(19) United States
(12) Patent Application Publication
(10) Pub. No.: US 2016/0134765 A1
(43) Pub. Date: May 12, 2016

(54) METHOD AND DEVICE FOR ADJUSTING PAPER FEEDING SPEED IN DIGITAL PRINTING SYSTEM

(71) Applicants: Peking University Founder Group Co., Ltd., Beijing (CN); Beijing Founder Electronics Co., Ltd., Beijing (CN); Peking University, Beijing (CN)

(72) Inventors: Cuiran YIN, Beijing (CN); Weiping HUANG, Beijing (CN); Zhihong LIU, Beijing (CN)

(21) Appl. No.: 14/442,127

(22) PCT Filed: Nov. 11, 2013
(86) PCT No.: PCT/CN2013/086851

§ 371 Date: May 12, 2015

(30) Foreign Application Priority Data
Nov. 12, 2012 (CN) 201210451781.7

(51) Int. Cl. H04N 1/00; B41J 13/00; G06K 15/16

(52) U.S. Cl. CPC H04N 1/00082; G06K 15/16; B41J 13/0009

(57) ABSTRACT

Disclosed are a method and device for adjusting a paper feeding speed in a digital printing system. The method comprises the following steps: determining that the received dot matrix data reaches a threshold which allows dot matrix data to be sent, and then sending the received dot matrix data to an imaging component; after sending the dot matrix data, adjusting the paper feeding speed of the imaging component according to the size of the remaining dot matrix data when it is determined that the size of the remaining dot matrix data is not within a preset range, thus improving the imaging speed and stability of the digital printing system.

### TECHNICAL FIELD

The present invention relates to a field of digital printing technology, and more specifically, to a method and a device for adjusting the paper feeding speed in a digital printing system.

### BACKGROUND

In recent years, the digital printing technology develops rapidly due to its advantage of very competitive cost and great flexibility. In comparison with the conventional printing method, the digital printing omits the complicated processes of pasteup, printing down, etc. Also, since the digital printing does not need lead or fire, it reduces a waste of resources and damages to the environment. At the same time, the digital printing can better ensure timeliness and accuracy, and therefore, it has unmatchable superiority, compared to the conventional printing.

The digital printing employs a method of directly transmitting, processing, printing data, i.e. data to be imaged is input once, a control system controls to image the data to be imaged. According to different ink-jet methods, the digital printing apparatus is classified as two: a continuous ink jettype and an on-demand ink jettype. For a digital printing apparatus of the on-demand ink-jet type, data to be imaged is under the control of the control system, and when the surface of a printing stock (e.g. paper) arrives at a predetermined position, the nozzles of the digital printing apparatus spray the ink according to a certain acting force and directly spay fog-like ink drops to the surface of the printing stock (e.g. paper) to form an image.

A lot of dot matrix data needs to be output during the digital printing process. Because of difference in dot matrix data compression ratio and difference in server performance, the output speed of dot matrix data varies. At present, the digital printing system usually employs a web to form the image continuously. In the digital printing process, if the processing speed and the output speed of the dot matrix data are smaller than the consumption speed of the dot matrix data, a severe printing problem will be caused, thereby leading to a waste of resources such as paper, manpower and time, etc. in order to avoid the waste of resources caused by the processing speed and the output speed of the dot matrix data not matching the consumption speed of the dot matrix data, it is necessary to ensure that the processing speed and the output speed of dot matrix data must be larger than the consumption speed of dot matrix data when printed. In a case where the grayscale, the resolution are consistent, and when printed, the consumption speed of dot matrix data to be imaged is in direct proportion to the paper feeding speed of paper.

For example, if the maximum processing speed of dot matrix data of the digital printing system is N, the consumption speed of dot matrix data when being printed must be smaller than N in a certain proportion, so that a case where the processing speed of dot matrix data is smaller than the consumption speed of dot matrix data can be avoided, and thereby ensuring the printing quality of the digital printing. Also, since the compression ratios of files to be printed are different, processing speed of the dot matrix for the system is also not fixed.

At present, the digital printing system processes dot matrix data, sends dot matrix data mainly by a server. In order to ensure that the output speed of dot matrix data is larger than the consumption speed of dot matrix data, it is necessary to ensure that the server processes dot matrix data and sends dot matrix data in a speed much larger than the consumption speed of dot matrix data during the printing. This imposes high requirements on the server processing dot matrix data and sending dot matrix data. If the output speed of dot matrix data in the digital printing process is improved by the server, the imaging speed, the average output speed and stability of the digital printing system will be affected.

### SUMMARY

An embodiment of the present invention provides a method and a device for adjusting the paper feeding speed in a digital printing system, which improves the printing quality of the digital printing system, reduces the waste of resources such as paper, manpower and time, and improves the imaging speed and stability of the digital printing system.

The specific technical solution provided by the embodiment of the present invention is as follows:

A method for adjusting a paper feeding speed in a digital printing system, characterized in that, the method comprising:

receiving dot matrix data to be imaged;

sending the received dot matrix data to an imaging component after determining that the received dot matrix data reaches a threshold which allows the dot matrix data to be sent; and

after sending the dot matrix data, adjusting the paper feeding speed of the imaging component according to a size of the remaining dot matrix data when it is determined that the size of the remaining dot matrix data is not within a preset range.

A device for adjusting a paper feeding speed in a digital printing system, which receives dot matrix data to be imaged and sends the received dot matrix data to an imaging component, characterized in that, the device comprises:

a processing unit configured to send the received dot matrix data to the imaging component after determining that the received dot matrix data reaches a threshold which allows the dot matrix data to be sent;

an adjustment unit configured to, after sending the dot matrix data, adjust the paper feeding speed of the imaging component according to a size of the remaining dot matrix data when it is determined that the size of the remaining dot matrix data is not within a preset range.

A device for adjusting the paper feeding speed in a digital printing system, which comprises a processor, said processor being configured to:

receive dot matrix data to be imaged;

send the received dot matrix data to an imaging component after determining that the received dot matrix data reaches a threshold which allows the dot matrix data to be sent; and

after sending the dot matrix data, adjust the paper feeding speed of the imaging component according to a size of the remaining dot matrix data when it is determined that the size of the remaining dot matrix data is not within a preset range.

A storage medium having program recorded thereon, said program causing a computer to perform the following processing:

receiving dot matrix data to be imaged;

sending the received dot matrix data to an imaging component after determining that the received dot matrix data reaches a threshold which allows the dot matrix data to be sent; and

after sending the dot matrix data, adjusting the paper feeding speed of the imaging component according to a size of the remaining dot matrix data when it is determined that the size of the remaining dot matrix data is not within a preset range.

In the embodiment of the present invention, by adjusting the paper feeding speed in the digital printing system, the output speed of dot matrix data is ensured to be much larger than the consumption speed of dot matrix data when printed, thereby ensuring the printing quality of the digital printing system. The specific method is: firstly, the digital printing system determines that the received dot matrix data reaches a threshold which allows dot matrix data to be sent, and then sends the received dot matrix data to an imaging component; after sending the above mentioned dot matrix data, adjusting the paper feeding speed of the imaging component according to the size of the remaining dot matrix data when it is determined that the size of the remaining dot matrix data is not within a preset range, thereby avoiding ensuring the output speed of dot matrix data to be much larger than the consumption speed of dot matrix data when printed, by a server, and at the same time, also avoiding the effect on the imaging speed and stability when the printing quality is improved by the server.

### BRIEF DESCRIPTION OF THE DRAWINGS

FIG. 1 is a schematic diagram of functional configuration of a digital printing system in an embodiment of the present invention;

FIG. 2 is a detailed flowchart of adjusting the paper feeding speed in a digital printing system in an embodiment of the present invention;

FIG. 3 is a detailed flowchart of adjusting the paper feeding speed when it is determined that the size of the remaining dot matrix data is not within a preset range in an embodiment of the present invention;

FIG. 4 is a specific detailed flowchart of adjusting the paper feeding speed in a digital printing system in an embodiment of the present invention;

FIG. 5 is a configuration example of adjusting the paper feeding speed in a digital printing system according to an embodiment of the present invention.

### DETAILED DESCRIPTION

In order to avoid the effect on the imaging speed and stability when the printing quality of the digital printing system is improved by the server, in the embodiment of the present invention, by adjusting the paper feeding speed in the digital printing system, the output speed of dot matrix data is ensured to be much larger than the consumption speed of dot matrix data during printing, thereby ensuring the printing quality of the digital printing system. That is, firstly, the digital printing system determines that the received amount of dot matrix data reaches a threshold which allows dot matrix data to be sent, and then sends the received dot matrix data to an imaging component; after sending the above dot matrix data, adjusting the paper feeding speed of the imaging component according to the size of the remaining dot matrix data when it is determined that the size of the remaining dot matrix data is not within a preset range, thereby avoiding the necessity of ensuring, by the server, the output speed of dot matrix data to be much larger than the consumption speed of dot matrix data when printing. At the same time, the effect on the imaging speed and stability when the printing quality is improved by the server may also be avoided.

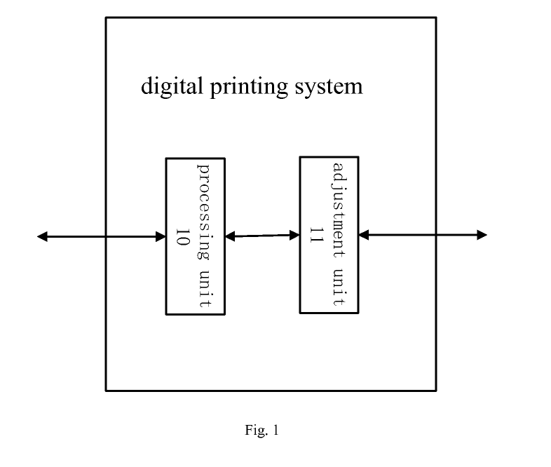

With reference to FIG. 1, in an embodiment of the present invention, a digital printing system includes a processing unit 10 and an adjustment unit 11, wherein

the processing unit 10 is for sending the received dot matrix data to the imaging component after determining that the received dot matrix data reaches a threshold which allows dot matrix data to be sent; and

the adjustment unit 11 is for, after sending the dot matrix data, adjusting the paper feeding speed of the imaging component according to the size of the remaining dot matrix data when it is determined that the size of the remaining dot matrix data is not within a preset range.

Hereinafter, a detailed explanation of a preferred embodiment of the present invention is given in conjunction with the drawings.

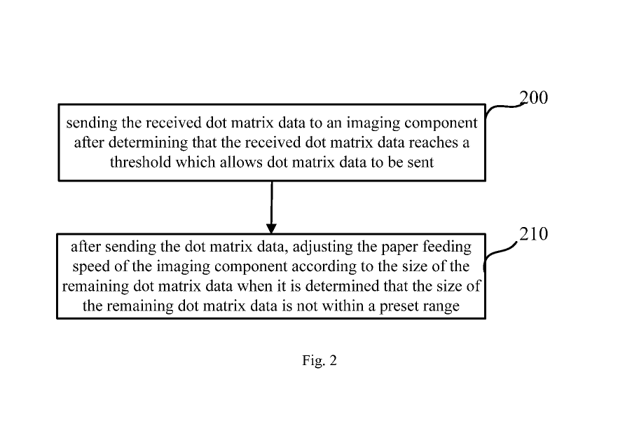

Based on the above mentioned technical solution, with reference to FIG. 2, in the embodiment of the present invention, the detailed flow of adjusting the paper feeding speed in the digital printing system is as follows:

Step 200: determining that dot matrix data received in a storage area reaches a threshold which allows dot matrix data to be sent, and then sending the received dot matrix data to an imaging component;

In the embodiment of the present invention, the imaging component refers to a component which prints or copies the dot matrix data.

In a practical application, in a case where the imaging component works well and the size of dot matrix data received in the imaging component does not reach the size of the memory of the imaging component, the imaging component may receive dot matrix data sent by the storage area; in a case where the imaging component works abnormally and/or the size of dot matrix data received in the imaging component has reached the size of the memory of the imaging component, the imaging component may not receive dot matrix data sent by the storage area.

In the embodiment of the present invention, the storage area receives dot matrix data. When the size of dot matrix data received in the storage area reaches a threshold which allows dot matrix data to be sent, the storage area sends a command to the imaging component for querying whether the imaging component may receive dot matrix data. In a case where the imaging component works well and the size of dot matrix data received in the imaging component does not reach the size of the memory of the imaging component, the imaging component sends feedback information to the storage area that it may receive dot matrix data; in a case where the imaging component works abnormally and/or the size of the received dot matrix data has reached the size of the memory of the imaging component, the imaging component sends feedback information to the storage area that it may not receive dot matrix data.

When the storage area receives feedback information indicating that the imaging component may receive dot matrix data, the storage area sends dot matrix data to the imaging component; and when the storage area receives feedback information indicating that the imaging component may not receive dot matrix data, the storage area does not send dot matrix data to the imaging component.

Preferably, in order to improve the printing quality of the digital printing system, when the storage area sends dot matrix data to the imaging component, it sends dot matrix data according a principle of “first in first out”.

So called “first in first out” means that the storage area sends dot matrix data to the imaging component according to the order in which it receives dot matrix data.

For example, the size of the storage area is M, the threshold which allows dot matrix data to be sent is 40% M. The storage area begins to receive dot matrix data from 1:10 a.m. At 1:40 a.m., the size of the received dot matrix data is 40% M. Then, the storage area sends a command to the imaging component for querying whether the imaging component may receive dot matrix data. When the imaging component sends feedback information indicating that it may receive dot matrix data to the storage area, the storage area sends dot matrix data to the imaging component. Furthermore, sending of dot matrix data received in the time period 1:10-1:20 a.m. is to be earlier than sending of dot matrix data received in the time period 1:20-1:30 a.m., and sending of dot matrix data received in the time period 1:20-1:30 a.m. is to be earlier than sending of dot matrix data received in the time period 1:30-1:40 a.m.

On the other hand, when the storage area sends dot matrix data to the imaging component, it may also send dot matrix data to the imaging component according to the priority of the file to be imaged.

For example, the size of the storage area is M, the threshold which allows dot matrix data to be sent is 40% M. The storage area begins to receive dot matrix data from 1:10 a.m. At 1:40 a.m., the size of the received dot matrix data is 40% M. Dot matrix data of a file A to be imaged is received in the time period 1:10-1:20 a.m., dot matrix data of a file B to be imaged is received in the time period 1:20-1:30 a.m., dot matrix data of a file C to be imaged is received in the time period 1:30-1:40 a.m. The storage area sends a command to the imaging component for querying whether the imaging component may receive dot matrix data. When the imaging component sends feedback information that it may receive dot matrix data to the storage area, since the priority of the file C to be imaged is higher than the priority of the file B to be imaged, and the priority of the file B to be imaged is higher than the priority of the file A to be imaged, when the storage area sends dot matrix data to the imaging component, it first sends dot matrix data of the file C to be imaged, then sends dot matrix data of the file B to be imaged, and finally sends dot matrix data of the file A to be imaged.

Step 210: after sending the dot matrix data, adjusting the paper feeding speed of the imaging component according to the size of the remaining dot matrix data when it is determined that the size of the remaining dot matrix data is not within a preset range.

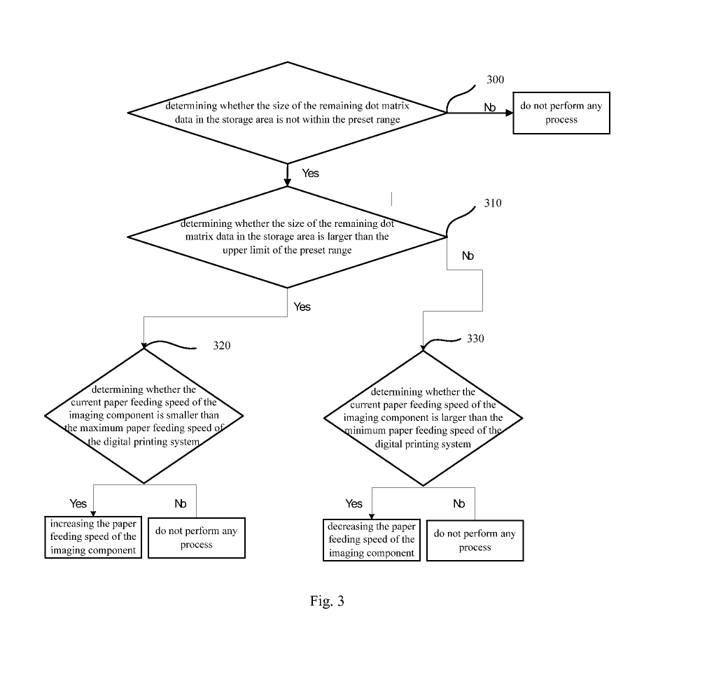

Preferably, the above step 210 is specifically carried out as shown in FIG. 3, which includes the following steps:

Step 300: determining whether the size of the remaining dot matrix data in the storage area is not within the preset range. If yes, step 310 is performed; if no, no process is performed.

In the embodiment of the present invention, the remaining dot matrix data in the storage area refers to dot matrix data obtained by subtracting dot matrix data sent to the imaging component by the storage area from dot matrix data received in the storage area.

The preset range is relevant to the digital printing system, and varies according to different digital printing systems. When the size of the remaining dot matrix data in the storage area is within the preset range, receiving and sending of dot matrix data of the storage area are kept in a balanced state, that is, the printing quality of the digital printing system is good.

When the size of the remaining dot matrix data in the storage area is not within the preset range, step 310 is performed; when the size of the remaining dot matrix data in the storage area is within the preset range, no process is performed.

For example, assuming that the size of the storage area of a digital printing system A is M, the preset range is 35% M-65% M when receiving and sending of dot matrix data of the storage area of the digital printing system A are kept in a balanced state. If the size of the remaining dot matrix data in the storage area is not within 35% M-65% M, i.e. the size of the remaining dot matrix data in the storage area is smaller than 35% M or larger than 65% M, step 310 is performed; if the size of the remaining dot matrix data in the storage area is within 35% M-65% M, no process is performed.

Step 310: determining whether the size of the remaining dot matrix data in the storage area is larger than the upper limit of the preset range. If yes, step 320 is performed; if no, step 330 is performed.

Step 320: determining whether the current paper feeding speed of the imaging component is smaller than the maximum paper feeding speed of the digital printing system. If yes, the paper feeding speed of the imaging component is improved; if no, no process is performed.

When the size of the remaining dot matrix data in the storage area is larger than the upper limit of the preset range, i.e. the current paper feeding speed of the imaging component is smaller than the output speed of dot matrix data, if the current paper feeding speed of the imaging component is smaller than the maximum paper feeding speed of the digital printing system, the paper feeding speed of the imaging component is improved.

Preferably, in order to ensure the printing quality of the digital printing system, when the current paper feeding speed of the imaging component is improved, the current paper feeding speed of the imaging component is improved evenly, i.e. each time the paper feeding speed of the imaging component is improved, it changes according to a set value N. That is to say, each time the value of the improved paper feeding speed of the imaging component is the current paper feeding speed of the imaging component +N.

For example, when the size of the remaining dot matrix data in the storage area is larger than the upper limit of the preset range, if the current paper feeding speed of the imaging component is 40 m/min and the maximum paper feeding speed of the digital printing system is 60 m/min, the current paper feeding speed of the imaging component is improved.

Preferably, in order to ensure the printing quality of the digital printing system, supposing that, each time, the current paper feeding speed of the imaging component is increased by 5 m/min evenly, the paper feeding speed of the imaging component after it is improved for the first time is 45 m/min, then the adjustment of the paper feeding speed ends, and the process returns to step 200 in FIG. 2. When next time it is determined in step 320 that the current paper feeding speed of the imaging component is smaller than the maximum paper feeding speed of the digital printing system, the paper feeding speed of the imaging component is improved again, the paper feeding speed of the imaging component after it is improved for the second time is 50 m/min.

In the embodiment of the present invention, if the size of the remaining dot matrix data in the storage area is still larger than the upper limit of the preset range after each time the current paper feeding speed of the imaging component is improved, the current paper feeding speed of the imaging component continues to improve until the size of the remaining dot matrix data in the storage area is between 35% M-65% M. When the current paper feeding speed of the imaging component is increased to the maximum paper feeding speed of the digital printing system, if the size of the remaining dot matrix data in the storage area is still larger than 65% M, increase of the paper feeding speed of the imaging component is stopped.

Step 330: determining whether the current paper feeding speed of the imaging component is larger than the minimum paper feeding speed of the digital printing system. If yes, the current paper feeding speed of the imaging component is reduced; if no, no process is performed.

When the size of the remaining dot matrix data in the storage area is smaller than the lower limit of the preset range, i.e. the current paper feeding speed of the imaging component is larger than the output speed of dot matrix data of the imaging component, if the current paper feeding speed of the imaging component is larger than the minimum paper feeding speed of the digital printing system, the current paper feeding speed of the imaging component is reduced.

Preferably, in order to ensure the printing quality of the digital printing system, when the current paper feeding speed of the imaging component is reduced, the current paper feeding speed of the imaging component is reduced evenly, i.e. each time the paper feeding speed of the imaging component is reduced, it changes according to a set value N. That is to say, each time the value of the reduced paper feeding speed of the imaging component is the current paper feeding speed of the imaging component −N.

For example, when the size of the remaining dot matrix data in the storage area is smaller than the lower limit of the preset range, if the current paper feeding speed of the imaging component is 60 m/min and the minimum paper feeding speed of the digital printing system is 40 m/min, the current paper feeding speed of the imaging component is reduced.

Preferably, in order to ensure the quality of images printed by the digital printing system, supposing that, each time, the current paper feeding speed of the imaging component is decreased by 5 m/min evenly, the paper feeding speed of the imaging component after it is reduced for the first time is 55 m/min, the paper feeding speed of the imaging component after it is reduced for the second time is 50 m/min.

In the embodiment of the present invention, if the size of the remaining dot matrix data in the storage area is still smaller than the lower limit of the preset range after the current paper feeding speed of the imaging component is reduced, the current paper feeding speed of the imaging component continues to reduce until the size of the remaining dot matrix data in the storage area is within 35% M-65% M. When the current paper feeding speed of the imaging component is decreased to the minimum paper feeding speed of the digital printing system, if the size of the remaining dot matrix data in the storage area is still smaller than 35% M, decrease of the current paper feeding speed of the imaging component is stopped.

In order to better understand the embodiment of the present invention, hereinafter, in combination with a specific application scenario, a process of adjusting the paper feeding speed in the digital printing system implemented according to the technical solution provided by the embodiment of the present invention is described in detail.

For convenience of explanation, the embodiment sets such an application scenario: the size of the storage area of a digital printing system A is M, the threshold of the storage area which allows dot matrix data to be sent is 40% M, the size of the remaining dot matrix data in the storage area is 28% M, the preset range when receiving and sending of dot matrix data of the storage area are kept in a balanced state is 38% M-68% M, the minimum paper feeding speed of the digital printing system A is 20 m/min, the maximum paper feeding speed is 70 m/min, the current paper feeding speed of the imaging component of the digital printing system A is 50 m/min.

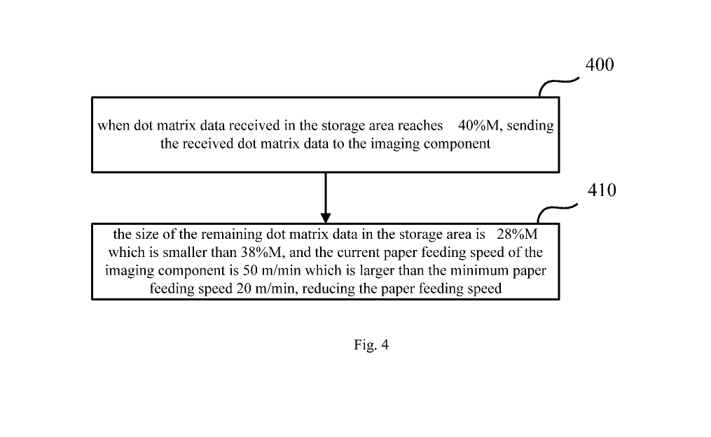

Based on the above setting, the detailed process of adjusting the paper feeding speed in the digital printing system is as shown in FIG. 4, which includes the following steps:

Step 400: when dot matrix data received in the storage area reaches 40% M, sending the received dot matrix data to the imaging component.

When dot matrix data received in the storage area reaches 40% M, the storage area sends a command to the imaging component for querying whether the imaging component may receive dot matrix data. When the storage area receives, from the imaging component, feedback information that the imaging component may receive dot matrix data, the storage area sends dot matrix data to the imaging component.

Step 410: the size of the remaining dot matrix data in the storage area is 28% M which is smaller than 38% M, and the current paper feeding speed of the imaging component is 50 m/min which is larger than the minimum paper feeding speed 20 m/min. Therefore, the paper feeding speed is reduced.

Preferably, in order to ensure the printing quality of the digital printing systems, supposing that, each time, the current paper feeding speed of the imaging component is decreased by 5 m/min evenly, the paper feeding speed of the imaging component after it is reduced for the first time is 45 m/min, the paper feeding speed of the imaging component after it is reduced for the second time is 40 m/min. At this time, when the size of the remaining dot matrix data in the storage area is still smaller than 38% M, the current paper feeding speed of the imaging component continues to reduce. When the current paper feeding speed of the imaging component is decreased to 20 m/min, if the size of the remaining dot matrix data in the storage area is still smaller than 38% M, decrease of the paper feeding speed of the imaging component is stopped.

In summary, in the embodiment of the present invention, by adjusting the paper feeding speed in the digital printing system, the output speed of dot matrix data is ensured to be larger than the consumption speed of dot matrix data during printing, thereby ensuring the printing quality of the digital printing system. The specific method is: firstly, the digital printing system determines that the received dot matrix data reaches a threshold which allows dot matrix data to be sent, and then sends the received dot matrix data to an imaging component; after sending the above mentioned dot matrix data, adjusting the paper feeding speed of the imaging component according to the size of the remaining dot matrix data when it is determined that the size of the remaining dot matrix data is not within a preset range, thereby avoiding ensuring , by a server, the output speed of dot matrix data to be much larger than the consumption speed of dot matrix data during the printing. At the same time, the effect on the imaging speed and stability when the printing quality is improved by the server is also avoided.

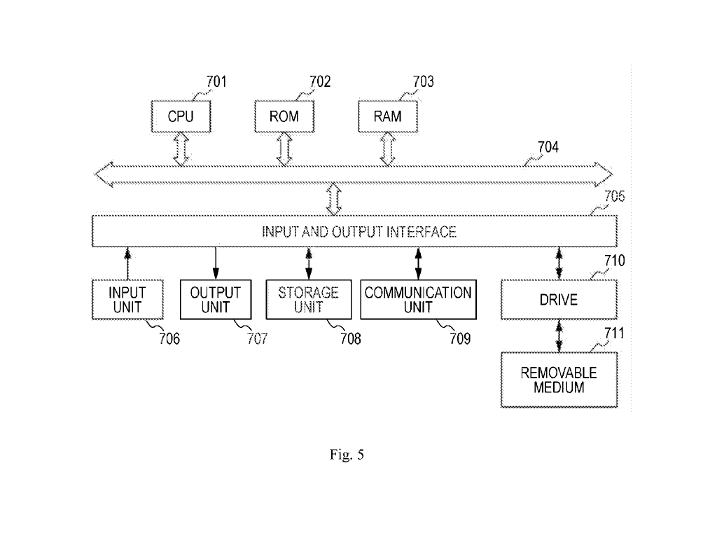

FIG. 5 shows an example of hardware configuration of a device for adjusting the paper feeding speed in a digital printing system according to the present invention.

A central processing unit (CPU) 701 functions as a data processing unit which performs various processes based on program stored on a read only memory (ROM) 702 or a storage unit 708. For example, CPU 701 performs the process based on the above mentioned sequence. A random access memory (RAM) 703 stores program, data, etc to be executed by the CPU 701. CPU 701, ROM 702 and RAM 703 are connected to each other via a bus 704.

CPU 701 is connected to an input and output interface 705 via the bus 704, and an input unit 706 constituted by various switches, keyboards, mice, microphones, etc and an output unit 707 constituted by a display, a speaker, etc are connected to the input and output interface 705. For example, CPU 701 performs various processes in response to instructions input from the input unit 706 and outputs the result of the processes to the output unit 707.

The storage unit 708 connected to the input and output interface 705 is for example constituted by a hard disc, and stores program and various data to be executed by the CPU 701 thereon. A communication unit 709 communicates with an external apparatus via a network such as Internet or local area network.

A drive 710 connected to the input and output interface 705 drives a removable medium 711 such as a magnetic disc, an optical disc, a magnetooptical disc or a semiconductor memory (e.g. a memory card), and acquires various data such as content and key information recorded thereon. For example, by using acquired content and key data, the process of adjusting the paper feeding speed in the digital printing system is executed by the CPU based on reproduced program.

The method and the system of the present invention may be embodied in many ways. For example, the method and the system of the present invention may be embodied by software, hardware, firmware or any combination of software, hardware, firmware. The above mentioned sequence for steps of the method of the present invention is only for illustration, steps of the method of the present invention are not limited to the above specifically described sequence, unless stated otherwise. In addition, in some embodiments, the embodiment of the present invention may be embodied as program recorded in a recording medium, these program includes machine readable instructions for carrying out the method of the present invention. Therefore, the present invention also includes a recording medium storing program for carrying out the method of the present invention thereon.

Obviously, those skilled in the art may make any modification and variation to the invention without departing from the spirit and scope of the invention. Therefore, if these modifications and variations of the invention are within the scope of the claims of the invention and equivalent thereof, the invention is also intended to cover these modifications and variations.

1. A method for adjusting a paper feeding speed in a digital printing system, characterized in that, the method comprising:
receiving dot matrix data to be imaged;
sending the received dot matrix data to an imaging component after determining that the received dot matrix data reaches a threshold which allows the dot matrix data to be sent; and
after sending the dot matrix data, adjusting the paper feeding speed of the imaging component according to a size of the remaining dot matrix data when it is determined that the size of the remaining dot matrix data is not within a preset range.

2. The method according to claim 1, characterized in that, when it is determined that the received dot matrix data reaches the threshold which allows dot matrix data to be sent, before sending the received dot matrix data to the imaging component, a query command is sent to the imaging component, and information is received from the imaging component that the dot matrix data may be received.

3. The method according to claim 1, characterized in that, the step of sending the received dot matrix data to the imaging component comprises:
sending the dot matrix data to the imaging component according to an order of receiving the dot matrix data; or
sending the dot matrix data to the imaging component according to a priority of the file to be imaged.

4. The method according to claim 1, characterized in that, the step of adjusting the paper feeding speed of the imaging component according to the size of the remaining dot matrix data when it is determined that the size of the remaining dot matrix data is not within a preset range comprising:
when it is determined that the size of the remaining dot matrix data is smaller than a lower limit of the preset range, if a current paper feeding speed of the imaging component is larger than a minimum paper feeding speed of the imaging component, reducing the current paper feeding speed of the imaging component until the size of the remaining dot matrix data is within the preset range; or
when it is determined that the size of the remaining dot matrix data is larger than an upper limit of the preset range, if the current paper feeding speed of the imaging component is smaller than the maximum paper feeding speed of the imaging component, improving the current paper feeding speed of the imaging component until the size of the remaining dot matrix data is within the preset range.

5. The method according to claim 4, characterized in that, when the current paper feeding speed of the imaging component is decreased to the minimum paper feeding speed of the imaging component and the size of the remaining dot matrix data is still smaller than the lower limit of the preset range, decrease of the current paper feeding speed of the imaging component is stopped; or
when the current paper feeding speed of the imaging component is increased to the maximum paper feeding speed of the imaging component and the size of the remaining dot matrix data is still larger than the upper limit of the preset range, increase of the current paper feeding speed of the imaging component is stopped.

6. A device for adjusting a paper feeding speed in a digital printing system, which receives dot matrix data to be imaged and sends the received dot matrix data to an imaging component, characterized in that, the device comprises:
a processing unit configured to send the received dot matrix data to the imaging component after determining that the received dot matrix data reaches a threshold which allows the dot matrix data to be sent;
an adjustment unit configured to, after sending the dot matrix data, adjust the paper feeding speed of the imaging component according to a size of the remaining dot matrix data when it is determined that the size of the remaining dot matrix data is not within a preset range.

7. The device according to claim 6, characterized in that, the processing unit is further configured to:
when it is determined that the received dot matrix data reaches a threshold which allows dot matrix data to be sent, before sending the received dot matrix data to the imaging component, send a query command to the imaging component and receive information from the imaging component, that the imaging component may receive dot matrix data.

8. The device according to claim 6, characterized in that, the processing unit is further configured to:
send the dot matrix data to the imaging component according to an order of receiving the dot matrix data; or
send the dot matrix data to the imaging component according to a priority of a file to be imaged.

9. The device according to claim 6, characterized in that, the adjustment unit is further configured to:
when it is determined that the size of the remaining dot matrix data is smaller than a lower limit of the preset range, if the current paper feeding speed of the imaging component is larger than the minimum paper feeding speed of the imaging component, reduce the current paper feeding speed of the imaging component until the size of the remaining dot matrix data is within the preset range; or
when it is determined that the size of the remaining dot matrix data is larger than an upper limit of the preset range, if the current paper feeding speed of the imaging component is smaller than the maximum paper feeding speed of the imaging component, improve the current paper feeding speed of the imaging component until the size of the remaining dot matrix data is within the preset range.

10. The device according to claim 9, wherein the adjustment unit is further configured to:
when the current paper feeding speed of the imaging component is decreased to a minimum paper feeding speed of the imaging component and the size of the remaining dot matrix data is still smaller than the lower limit of the preset range, stop decrease of the current paper feeding speed of the imaging component; or
when the current paper feeding speed of the imaging component is increased to a maximum paper feeding speed of the imaging component and the size of the remaining dot matrix data is still larger than the upper limit of the preset range, stop increase of the current paper feeding speed of the imaging component.

11. A device for adjusting the paper feeding speed in a digital printing system, which comprises a processor, said processor being configured to:
receive dot matrix data to be imaged;
send the received dot matrix data to an imaging component after determining that the received dot matrix data reaches a threshold which allows the dot matrix data to be sent; and
after sending the dot matrix data, adjust the paper feeding speed of the imaging component according to a size of the remaining dot matrix data when it is determined that the size of the remaining dot matrix data is not within a preset range.

12. A storage medium having program recorded thereon, said program causing a computer to perform the following processing:
receiving dot matrix data to be imaged;
sending the received dot matrix data to an imaging component after determining that the received dot matrix data reaches a threshold which allows the dot matrix data to be sent; and
after sending the dot matrix data, adjusting the paper feeding speed of the imaging component according to a size of the remaining dot matrix data when it is determined that the size of the remaining dot matrix data is not within a preset range.
